(19) United States
(12) Patent Application Publication
(10) Pub. No.: US 2003/0117800 A1
(43) Pub. Date: Jun. 26, 2003

(54) Combinative lightening device for a pattern

(75) Inventor: Peter K. H. Huang, Taipei (TW)

Correspondence Address: BRUCE H. TROXELL, SUITE 1404, 5205 LEESBURG PIKE, FALLS CHURCH, VA, 22041, US

(73) Assignee: Shining Blick Enterprises Co., Ltd.

(21) Appl. No.: 10/025,606

(22) Filed: Dec. 26, 2001

(51) Int. Cl. F21S 13/14

(52) U.S. Cl. 362/252; 362/249; 362/565; 362/806

(57) ABSTRACT

A combinative lightening device for a pattern, wherein, the particular decorative pattern is composed of a first and a second component plane sheet connected with each other, and a lightening lamp support provided between the first and the second component plane sheets, at least a lamp bulb is mounted on the lightening lamp support and arranged at a desired position in corresponding to the shape of the pattern. In a preferred embodiment, one of the first and second component plane sheets has a given lateral thickness in corresponding to the shape of the pattern, while the other component plane sheet is a real plane sheet, hence the two component plane sheets form a relief state, alternatively, the first and second component plane sheets each has a given lateral thickness to form together a cubic pattern.

### BACKGROUND OF THE INVENTION

1. Field of the Invention

The present invention is related to a combinative lightening device for a pattern, and especially to a lightening device capable of providing variant three-dimensional or relief decorations.

2. Description of the Prior Art

Early conventional Christmas lamp strings only have a lot of lamb bulbs connected serially in a long strip, and are unable to construct particular products with patterns. In the recent years, there are various patterns (such as Sancta Claus, Christmas trees etc.) which are made each in a plastic lamp support, the lamp support then is mounted thereon with a lot of lamb bulbs and is electrically connected to make the patterns lighten and flash. However, these earlier “figure lights” all lighten each on one side; the inventor of the present invention has a U.S. Pat. No. 5,712,770 which is improved upon such “figure lights” to make both sides of each “figure light” lighten.

However, such “figure lights” having both sides lightened, the function of decoration of them still is limited to the plastic lamp support, variation of decoration of them is nevertheless inadequate.

### SUMMARY OF THE INVENTION

The object of the present invention is to provide a combinative lightening device for a pattern, wherein, the particular decorative pattern is composed of a first and a second component plane sheet, and a lightening lamp support provided between the first and the second component plane sheets. Thereby, the lamp bulbs mounted on the lightening lamp support can be arranged at desired positions in corresponding to the shape of the decorative pattern to form a much variable lightening device.

In the practical embodiments, one of the component plane sheets can be molded in vacuum to be three-dimensional, while the other component plane sheet can be a real plane sheet, hence a relief patterned lightening device can be formed.

In another practical embodiment, the abovementioned first and the second component plane sheets can both be three-dimensional to form a desired decorative pattern, and to form an upright standing lightening device.

The present invention will be apparent in its novelty and features after reading the detailed description of the preferred embodiment thereof in reference to the accompanying drawings.

### BRIEF DESCRIPTION OF THE DRAWINGS

FIG. 1 is a perspective view of the first embodiment of the present invention;

FIG. 2 is an anatomic perspective view further showing the elements in FIG. 1;

FIG. 3 is an anatomic perspective view of the second embodiment of the present invention similar to that of FIG. 1;

FIG. 4 is an anatomic perspective view of the third embodiment of the present invention;

FIG. 5 is a perspective view showing mounting of the relief embodiment of FIG. 4 on a wall for decoration;

FIG. 6 is a perspective view of the fourth embodiment in a cubic fashion of the present invention similar to that of FIG. 4;

FIG. 7 is a perspective view of the fifth embodiment of the present invention shown in a relief style;

FIG. 8 is a perspective view of the sixth embodiment of the present invention similar to that of FIG. 7.

### DETAILED DESCRIPTION OF THE PREFERRED EMBODIMENT

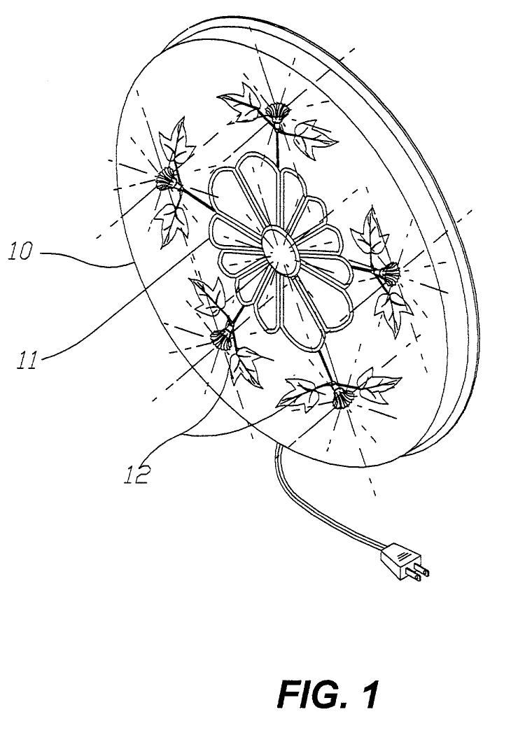

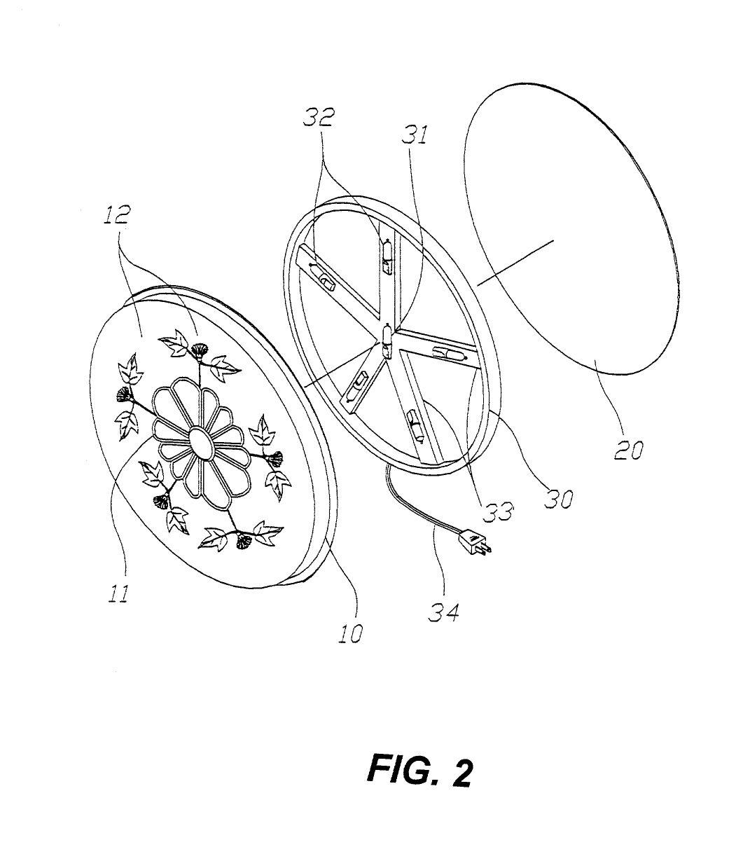

Referring to FIGS. 1 and 2, the present invention includes at least a first component plane sheet 10 with a pattern thereon, a second component plane sheet 20 forming the desired pattern with the first component plane sheet 10, and a lightening lamp support 30 provided between the first and the second component plane sheets 10 and 20 to provide a decorative lightening effect. The first and the second component plane sheets 10, 20 had better be made of transparent materials.

In the embodiment as shown in FIG. 1, the first component plane sheet 10 is made three-dimensional by molding in vacuum, and has a central main flower pattern 11, a plurality of flowers 12 with branches and leaves thereon extend outwardly. This embodiment shows that the first component plane sheet 10 has a given lateral thickness to form a desired cubic fashion; while the second component plane sheet 20 is a real plane sheet being processed to connect with the rear side of the first component plane sheet 10 to form the desired whole lightening device. However, this is not limitative, in the practicable embodiment, the first component plane sheet 10 can be a real plane sheet, while the second component plane sheet 20 can have a given lateral thickness to form together a desired cubic lightening patterned device.

The lightening lamp support 30 is provided between the first and the second component plane sheets 10 and 20 to be in the shape in coincident with those of these component plane sheets 10, 20, and is a hollow annular ring, it is provided respectively on the central main flower pattern 11 and the surrounding flowers 12 having branches and leaves with lamp bulbs 31, 32. The lamp bulbs 31, 32 are all positioned on a plurality of radially extending spokes 33. In this practicable embodiment, the lamp bulbs 31, 32 can be serially connected to form a lamp string, and are electrically connected by an external conductor 34, so that the whole lightening patterned device can have the decoration function of lightening and flashing.

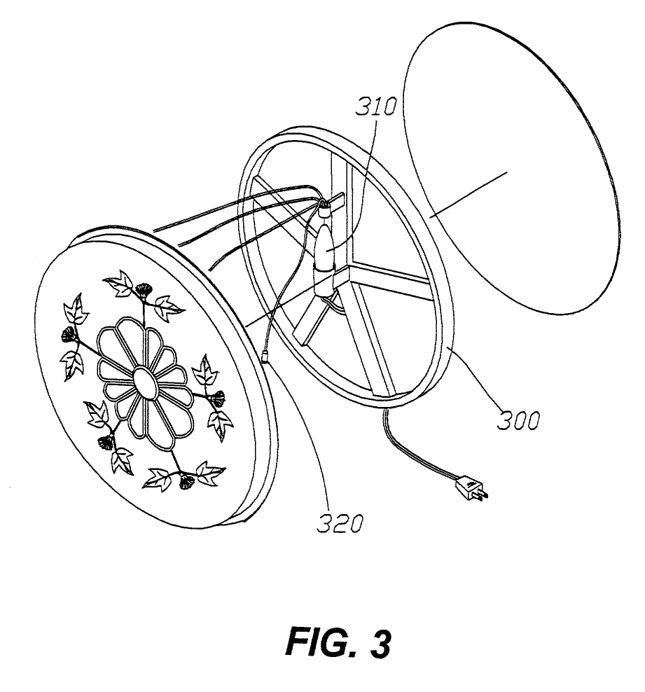

In the second embodiment of the present invention shown in FIG. 3, a lightening lamp support 30 uses a single central main lamp bulb 310, it is connected with a plurality of small lamp bulbs 320 via additional conductors, so that the small lamp bulbs 320 can take advantage of the conductors to be flexibly stretched and accurately positioned at a plurality of peripheral positions on the pattern.

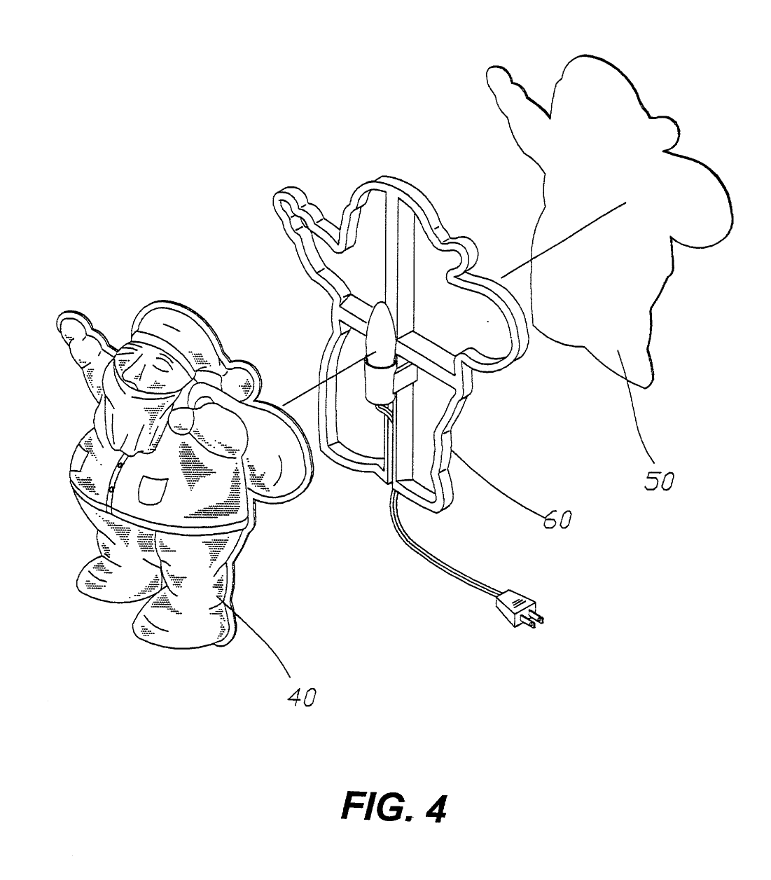

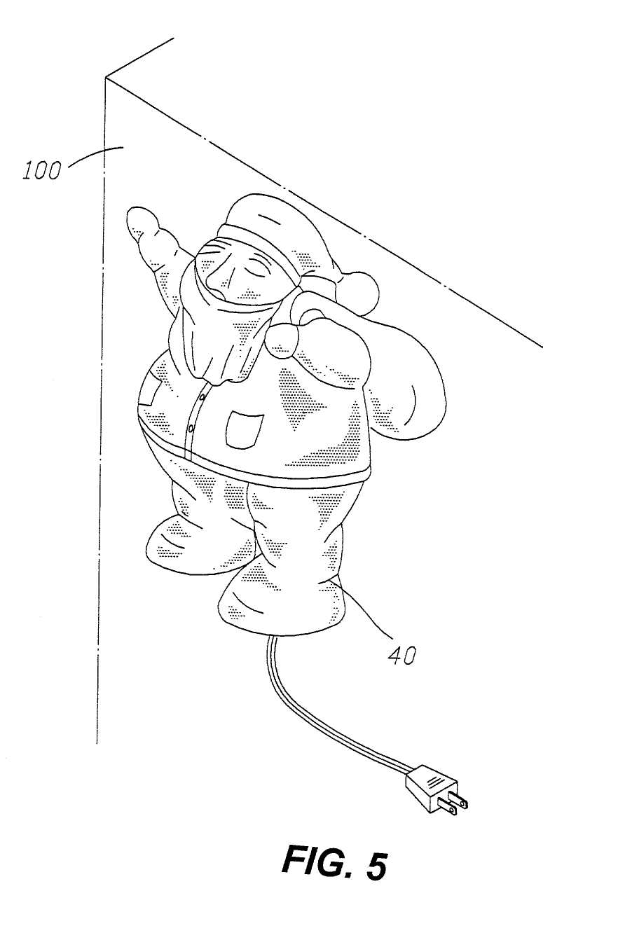

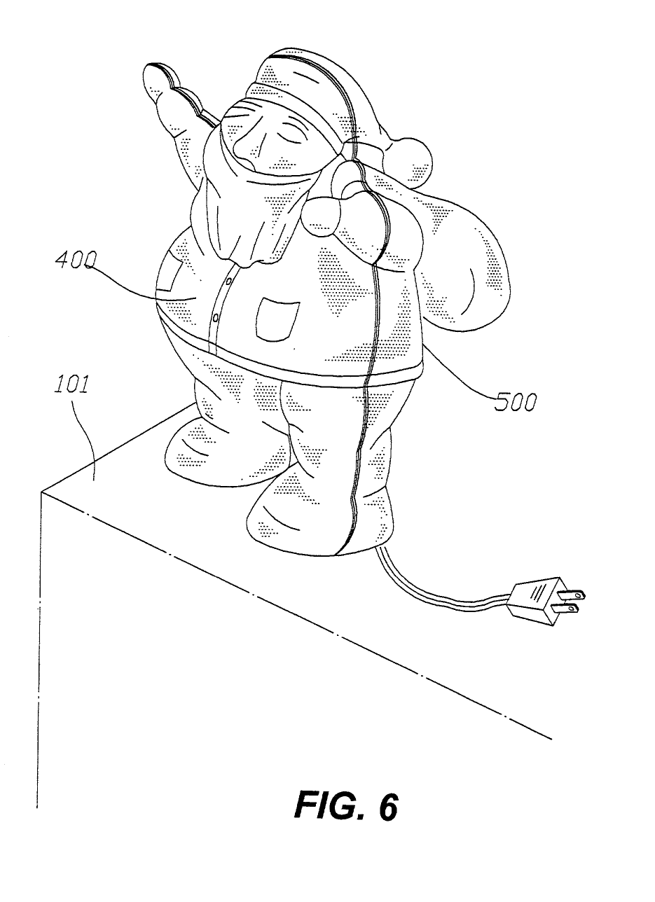

Referring to FIG. 4, in the third embodiment of the present invention which is similar to the above embodiment, there are also a first component plane sheet 40, a second component plane sheet 50 and a lightening lamp support 60 forming a pattern of Santa Claus. The entire lightening device thereby can be, as shown in FIG. 5, mounted on a wall 100 for decoration in a relief style. Among those practicable embodiments, as shown in FIG. 6, the fourth embodiment of the present invention similar to the third embodiment can make a second component plane sheet 500 be in the shape in coincident with that of a first component plane sheet 400, and can stand upright on a surface 101 for decoration.

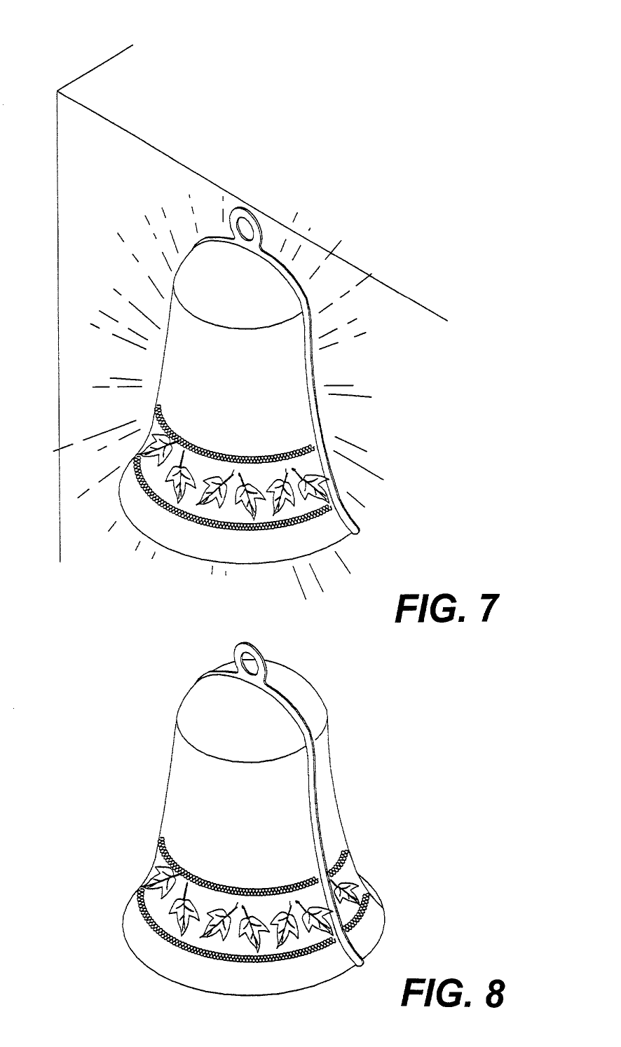

In either of the embodiments of the present invention shown in FIGS. 7,8, a lightening patterned device is in the shape of a Christmas bell respectively of a relief style (FIG. 7) and a cubic fashion (FIG. 8).

By reason that the present invention can get a combinative lightening decoration product, the internal lightening lamp support thereof can totally be in correspondence with the apparent pattern, thereby, variation of decorative function of the present invention can be obtained, and the present invention can get desired decorative as well as advertisement effect in adequately meeting the environmental conditions to be decorated with it.

The embodiments cited above are only for illustrating a preferred embodiment of the present invention. It will be apparent to those skilled in this art that various modifications or changes can be made to the elements of the present invention without departing from the spirit and scope of this invention. Accordingly, all such modifications and changes also fall within the scope of the appended claims and are intended to form part of this invention.

1. A combinative lightening device for a pattern, wherein, said pattern which is a particular decorative pattern is composed of a first and a second component plane sheet connected with each other, and a lightening lamp support provided between said first and said second component plane sheets, a plurality of lamp bulbs mounted on said lightening lamp support are arranged at desired positions in corresponding to the shape of said pattern.

2. A combinative lightening device for a pattern as claimed in claim 1, wherein, one of said first and second component plane sheets has a given lateral thickness; while the other of said first and second component plane sheets is a real plane sheet being processed to connect with said former one component plane sheet, hence said two component plane sheets form a relief state.

3. A combinative lightening device for a pattern as claimed in claim 1, wherein, said first and second component plane sheets each has a given lateral thickness to form together a cubic pattern.

4. A combinative lightening device for a pattern as claimed in claim 1, 2 or 3, wherein, said lamp bulbs mounted on said lightening lamp support are arranged directly at desired positions in correspondence with said pattern on said first and second component plane sheets.

5. A combinative lightening device for a pattern as claimed in claim 1, 2 or 3, wherein, said lamp bulbs mounted on said lightening lamp support are arranged at desired positions in correspondence with said pattern on said first and second component plane sheets by connecting and stretching of conductors.
